(19) United States
(12) Patent Application Publication
(10) Pub. No.: US 2014/0178633 A1
(43) Pub. Date: Jun. 26, 2014

(54) Composite Material and Structural Components of a Motor Vehicle

(71) Applicants: Oliver Kleinschmidt, Dortmund (DE); Peter Klauke, Schwerte (DE); Thorsten Boeger, Duisburg (DE); Ingo Rogner, Ingolstadt (DE); Oliver Hennig, Bad Fallingbostel (DE); Christoph Filthaut, Dortmund (DE); Lothar Patberg, Moers (DE); Stefan Mayer, Schwerte (DE)

(72) Inventors: Oliver Kleinschmidt, Dortmund (DE); Peter Klauke, Schwerte (DE); Thorsten Boeger, Duisburg (DE); Ingo Rogner, Ingolstadt (DE); Oliver Hennig, Bad Fallingbostel (DE); Christoph Filthaut, Dortmund (DE); Lothar Patberg, Moers (DE); Stefan Mayer, Schwerte (DE)

(73) Assignee: ThyssenKrupp Steel Europe AG, Duisburg (DE)

(21) Appl. No.: 14/006,178

(22) PCT Filed: Mar. 21, 2012
(86) PCT No.: PCT/EP2012/054940

§ 371 Date: Dec. 17, 2013

(30) Foreign Application Priority Data
Mar. 24, 2011 (DE) 10 2011 015 071.4

(51) Int. Cl. B32B 15/14; B32B 27/06; B32B 5/02

(52) U.S. Cl. CPC B32B 15/14; B32B 5/02; B32B 27/06
USPC 428/138; 428/221; 442/316; 442/232; 428/332; 428/172; 428/212; 428/220

(57) ABSTRACT

A composite material is shown and described in the form of a laminated material made of flat superimposed layers for production of a structural component, in particular for structural components of a motor vehicle, comprising at least one metal layer and at least one fibre-reinforced plastic layer. In order to achieve firstly a reduction in weight and secondly an increase in strength of a structural component made from the composite material, with a reduction in component costs, it is provided that the fibre-reinforced plastic layer has a matrix based on polypropylene, polyethylene, polyamide and/or mixtures thereof.

The invention concerns a composite material in the form of a laminated material made of flat superimposed layers for production of a structural component, in particular for motor vehicles, by forming, comprising at least one metal layer and at least one fibre-reinforced plastic layer. The invention furthermore comprises a structural component made from such a composite material.

For various applications there is a need for components which have a low weight without loss of component strength. DE 600 11 917 T2 discloses a composite material and a structural component made therefrom which has two metallic cover layers, between which is provided a fibre-reinforced plastic layer. Furthermore DE 102 21 582 A1 discloses a vehicle body component with a metallic layer and a fibre-reinforced plastic layer.

In the production of motor vehicles, both weight saving and component strength have great importance. For safety reasons therefore it must be ensured that component failure is avoided in proper operation and in the event of a crash, high forces can be absorbed or dissipated. At the same time, in particular in the automotive industry, there is a high cost awareness so that the structural components must be produced ever more cheaply. To fulfil these requirements there is a further need for optimisation with regard to the known composite materials.

The present invention is therefore based on the object of structuring and refining the composite materials and structural components cited initially and described above such that with a reduction of component costs, firstly a reduction in weight and secondly an increase in strength and/or rigidity of the structural components can be achieved.

The object cited above is achieved by a composite material according to the preamble of claim 1 in that the fibre-reinforced plastic layer has a matrix based on polypropylene, polyethylene, polyamide and/or a mixture thereof.

Furthermore the object cited above is achieved by a structural component according to claim 15 in that the composite material is a composite material according to any of claims 1 to 14.

The invention has found that by use of a matrix of a fibre-reinforced plastic layer based on polypropylene, polyethylene, polyamide and/or mixtures thereof, the material properties of the composite material or structural component can be influenced with regard firstly to a reduction in weight and secondly to an increase in strength and/or rigidity, in a surprisingly economic manner. The fibre-reinforced plastic layer can firstly be produced at low costs and secondly allows such high strengths and/or rigidities that the strength and/or rigidity requirements for the metallic layer are reduced. The metallic layer can therefore be formed from a cheap metal with a low layer thickness. Overall, even in comparison with composite materials which have a more favourable fibre-reinforced plastic layer, the result is a cost saving for the composite material and hence for the structural component.

A further advantage of the composite material or structural component is that this can be subjected to coating, in particular to cathodic dip coating.

Composite materials in the sense of the invention are laminated materials which are formed by flat superimposed layers. The layers preferably have constant or at least even layer thicknesses. Preferably structural components are produced from the composite materials by forming.

Structural components are mainly for example chassis components, parts of the underfloor, floor panels, floor assemblies, door impact carriers, roof reinforcements, window frame reinforcements, bumpers, reinforcements of A, B and/or C pillars, the A, B and/or C pillars themselves, dashboard carriers, battery housing, tank containers, water reservoirs, spare wheel wells etc. Structural components can if necessary also be parts of the visible outer skin of a motor vehicle, even if these primarily have no supporting function in proper operation of the motor vehicle. In particular however because of the material properties, structural components are components which have a supporting function and/or serve to absorb and/or dissipate forces which act on the vehicle in the event of a crash. Suspension parts are in particular cross members, subframes, control arms, pivot bearings, antiroll bars, engine cross members, torsion beam axles, wheel guide modules and/or wheel holders. Chassis parts are generally components which are in functional connection with the chassis or driving properties of the motor vehicle and hence the safety requirements for motor vehicles. Motor vehicles in this context can also be commercial vehicles such as goods vehicles, busses and tractors. Rail vehicles are also included, as are applications in the aviation and aerospace industries.

Applications of the composite material or corresponding structural components can also lie in construction, for example in elevators, but also in plants for exploitation of renewable energy, for example wind force and solar heating. In principle all applications are conceivable in which masses are moved and in which weight must be reduced, with high strength and/or rigidity.

Preferably the metallic layer is provided as the outer layer as this can protect the fibre-reinforced plastic from unfavourable effects from the outside such as impacts, increased temperatures etc. To allow as even or symmetrical a force development in the structural component as possible, or to be able to protect the fibre-reinforced plastic against external effects from both sides, two metallic layers can be provided which are then preferably provided as outer layers of the composite. The outer layers can also favourably affect the forming of the composite material into a structural component. On use of a plurality of metallic layers, for said reasons and for production reasons it is suitable if the plurality of metallic layers comprises the same thickness and/or same material.

The one metallic layer or plurality of metallic layers can also perform a safety function and prevent total failure of the structural component if the fibre-reinforced plastic layers fails even at low elongation.

In a first preferred embodiment of the composite material at least one fibre-free plastic layer is also provided. This can be formed such that it can tolerate a higher elongation and where applicable counter total failure. Alternatively or additionally the fibre-free plastic layer can serve to absorb compression forces. In principle it is suitable if the at least one fibre-free plastic layer is also based on polypropylene, polyethylene, polyamide or mixtures thereof. This leads to an improvement in the properties of the composite and/or the adhesion or connection between the fibre-reinforced and the fibre-free plastic layers if, as preferred, these are provided adjacent to each other. In particular it is preferred if the plastics of the fibre-free plastic layer and the matrix of the fibre-reinforced plastic layer are similar or even identical.

The preferably polyamide-based matrix of fibre-reinforced plastic layer and/or fibre-free plastic layer can preferably comprise polyethylene (PE). The polyamide (PA) and polyethylene then do not form separate layers. Rather said plastics form a blend. The polyethylene, in particular because of its temperature-dependent properties, promotes the workability, in particular the formability of the composite material. The proportion of polyethylene in the plastic matrix or plastic layer can be 3 w. % to 40 w. %, preferably 5 w. % to 20 w. %.

Alternatively or additionally the matrix of the plastic layer and/or the fibre-free plastic layer can comprise styrene maleic acid anhydride (SMA) to improve the adhesion properties of the corresponding layer. This is the case in particular if further components such as polyethylene, which have reduced adhesion properties, are added to the polyamide. With regard to adhesion, in particular adhesion to the metallic layer can be problematic. Also by addition of styrene maleic acid anhydride, a demixing and hence more even distribution of further components in the polyamide can be improved.

This is the case in particular with regard to added polyethylene. The proportion of styrene maleic acid anhydride in the plastic matrix of the plastic layer can be 0.5 w. % to 10 w. %, preferably 0.5 w. % to 5 w. %.

The proportion of fibres in the at least one fibre-reinforced plastic layer can be up to 65 vol. % in relation to the fibre-reinforced plastic layer, and in relation to the composite material between 5 vol. % and 40 vol. %, preferably between 5 vol. % and 20 vol. %, in particular between 5 vol. % and 15 vol. %, in order to achieve a good strength, rigidity and/or processability of the composite material.

The fibres in the fibre-reinforced plastic layer are inorganic fibres, organic fibres and/or plastic fibres, namely depending on the desired properties. Inorganic fibres can preferably be glass fibres, boron fibres and basalt fibres, whereas organic fibres can in particular be carbon fibres and protein fibres. Plastic fibres can be aramide fibres or polyethylene fibres.

In addition the properties of the composite material or structural component can be set by the manner of arrangement of the fibres in the matrix of the fibre-reinforced plastic layer. In principle the arrangement can be isotropic or anisotropic, depending on whether the tensile strength is to be isotropic or anisotropic. The fibres can be distributed stochastically or in an ordered fashion, preferably as a laid, knitted or woven fabric or fleece and/or unidirectional layers in the fibre-reinforced plastic layer. In particular in unidirectional layers, a maximum tensile strength of structural components, in particular those stressed under tension, can be set in a preferential direction of the fibres. Also in particular complex structural components can be produced without difficulty by forming if the fibres are oriented unidirectionally and folds run substantially parallel to the fibre orientation.

Because of the material properties and costs, it is suitable if the at least one metal layer is made of a steel, for example carbon steel or stainless steel, or an aluminium material. Aluminium is preferred over steel not because of the cost but because of the weight.

Because of the high tensile strength of the fibre-reinforced plastic layer, it is sufficient if the metal layer has a tensile strength which corresponds at most to the tensile strength of the fibre-reinforced plastic layer, in particular is maximum 700 MPa, preferably maximum 650 MPa and particularly preferably less than 450 MPa. The lower the tensile strength requirements for the metallic layer, the more suitable is a more economic metal. In this context the steel qualities DX 56, HX 220 BD, HC 340 LA and HCT 600 X may be preferred.

Because of the high tensile strength of the fibre-reinforced plastic layer, alternatively or additionally very thin metal layers can be provided which can have a thickness between 0.1 mm and 1 mm, preferably maximum 0.75 mm.

To save metal and hence weight and/or costs, the at least one metal layer can have recesses, indentations and/or openings. These are then arranged preferably evenly distributed over the metal layer.

To save metal and hence weight and/or costs, the at least one metal layer can alternatively have a proportion of maximum 50 vol. % in relation to the composite material. Alternatively or additionally it can be provided that the cross sections of the composite material have a maximum metal proportion of 50%.

To keep weight and costs of the composite material as a whole low, the total thickness of the composite material can be between 0.5 mm and 4.0 mm, in particular between 1.0 mm and 3.0 mm.

An improved adhesion between metal and plastic in the composite material can be achieved if an adhesion promotion agent, in particular with a thickness of 0.01 mm and 0.05 mm, is provided adjacent firstly to the fibre-reinforced or fibre-free plastic layer and secondly to the at least one metal layer.

The advantages of the invention are shown as an example in the examples described below.

### EXAMPLE 1

The tensile strengths of a composite material with two outer metallic layers of thickness t=0.25 mm, two fibre-reinforced metallic plastic layers with thickness t=0.25 mm adjacent to the metallic layers, and a middle fibre-free plastic layer of thickness t=0.5 mm, arise theoretically from the cross section ratios (mixing formula) for metallic layers according to table 1, giving the tensile strengths Rₘ given in table 2.

The fibre-reinforced plastic layer has a polyamide matrix and a fabric of carbon fibres running at right angles to each other and a fibre proportion of 45 vol. %. The tensile strength and density of the fibre-reinforced plastic layer are Rₘ=785 MPa and ρ=1.43 g/cm³. The tensile strength of the fibre-free plastic layer of polyamide is not taken into account in the calculations.

TABLE 1
(steel)

| Steel Quality | Rₘ [Mpa] |
|---|---|
| DX 56 | 260 |
| HX 220 BD | 320 |
| HC 340 LA | 410 |
| HCT 600 X | 600 |

TABLE 2
(composite material)

| Steel Quality | Rₘ [Mpa] |
|---|---|
| DX 56 | 523 |
| HX 220 BD | 553 |
| HC 340 LA | 444 |
| HCT 600 X | 618 |

### EXAMPLE 2

For a composite material of layer thickness t=1.5 mm with two outer metallic layers, a middle polyamide-based fibre-reinforced plastic layer and two polyamide-based fibre-free plastic layers between the metallic layers, theoretically the tensile strengths given in tables 3 and 4 arise depending on the layer thickness firstly of the individual metallic layers t_{MS} and secondly of the fibre-reinforced plastic layer t_{FK}. The materials of the metallic layers and fibre-reinforced plastic layer correspond to those of example 1. The tensile strength of the fibre-free plastic layer of polyamide is not taken into account in the calculation.

TABLE 3

| t_{MS} = 0.5 | DX 56 | HX 220 BD | HC 340 LA | HCT 600 X |
|---|---|---|---|---|
| t_{FK} (mm) | Rₘ [Mpa] | Rₘ [Mpa] | Rₘ [Mpa] | Rₘ [Mpa] |
| 0.25 | 365 | 413 | 485 | 637 |
| 0.5 | 433 | 473 | 533 | 661 |
| 0.75 | 485 | 520 | 571 | 680 |

TABLE 4

| t_{MS} = 0.75 | DX 56 | HX 220 BD | HC 340 LA | HCT 600 X |
|---|---|---|---|---|
| t_{FK} (mm) | Rₘ [Mpa] | Rₘ [Mpa] | Rₘ [Mpa] | Rₘ [Mpa] |
| 0.25 | 333 | 385 | 462 | 625 |
| 0.5 | 391 | 436 | 501 | 646 |
| 0.75 | 433 | 473 | 533 | 661 |

The invention is now explained below with reference to a drawing showing merely exemplary embodiments. The drawing shows:

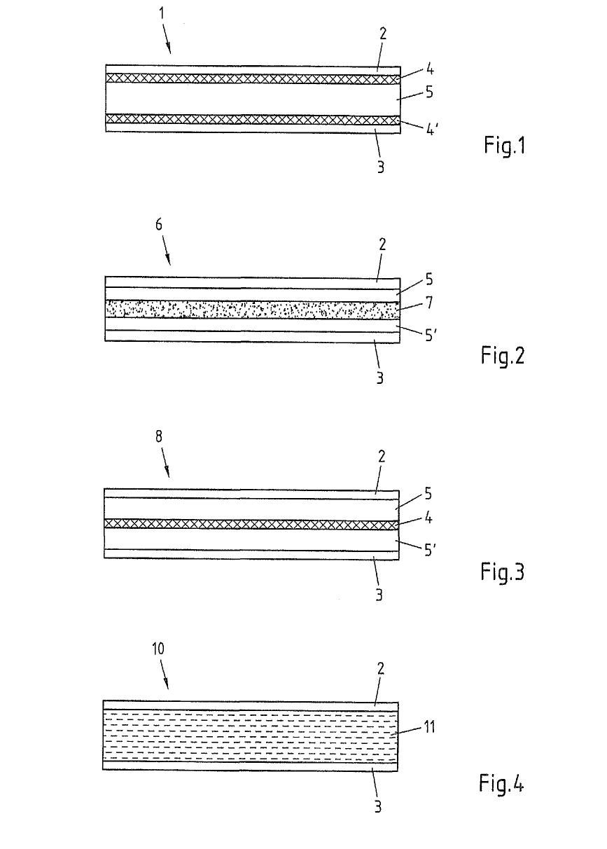

FIGS. 1 to 8 layer structures of eight embodiment examples of the composite material according to the invention in diagrammatic depiction,

FIG. 9 an embodiment example of the structural component according to the invention in perspective view.

FIG. 1 shows a layer structure of a composite material 1 which has two outer metallic layers 2, 3 as outer cover layers. Adjacent to the metallic layers 2, 3 are fibre-reinforced plastic layers 4, 4′ which are made of a polyamide-based matrix with a fibre fabric laid therein. A core layer in the form of a fibre-free plastic layer 5 is enclosed by the fibre-reinforced plastic layers 4, 4′.

FIG. 2 shows a layer structure of a composite material 6 which has two outer metallic layers 2, 3 as outer cover layers. Adjacent to the metallic layers 2, 3 in this embodiment example are two fibre-free plastic layers 5, 5′ which in turn border on both sides a fibre-reinforced plastic layer 7. The fibre-reinforced plastic layer 7 has a polyamide matrix and a fabric with carbon fibres running at right angles to each other and a fibre proportion of 45 vol. %. The tensile strength and density of the fibre-reinforced plastic layer are Rₘ=785 MPa and ρ=1.43 g/cm³.

FIG. 3 shows a layer structure of a composite material 8 which has two outer metallic layers 2, 3 as outer cover layers. Adjacent to the metallic layers 2, 3 in this embodiment example are two fibre-free plastic layers 5, 5′ which in turn border on both sides a fibre-reinforced plastic layer 4. The fibre-reinforced plastic layer 4 in this case is formed by a fibre fabric in a polyamide-based matrix.

FIG. 4 shows a layer structure of a composite material 10 with two outer metallic layers 2, 3 as outer cover layers. Between the two outer cover layers is a core layer of a fibre-reinforced plastic 11. The matrix consists of a polyamide-based plastic in which short fibres are distributed oriented in a preferential direction.

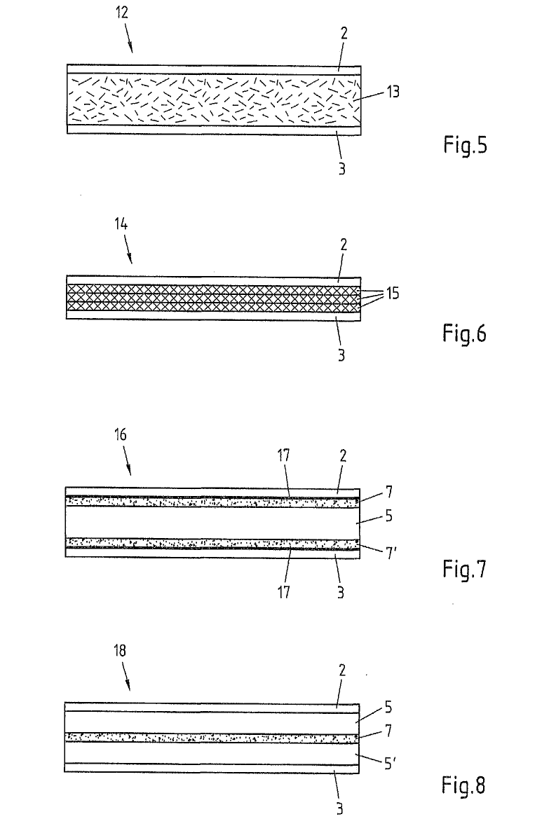

FIG. 5 shows a layer structure of a composite material 12 which has two outer metallic layers 2, 3 as outer cover layers. Between the two outer cover layers is a core layer of a fibre-reinforced plastic 13. The matrix consists of a polyamide-based plastic in which fibres are provided distributed stochastically.

FIG. 6 shows a layer structure of a composite material 14 which has two outer metallic layers 2, 3 as outer cover layers. Between the two outer cover layers is a core layer which is composed of three separate, mutually adhering layers of fibre-reinforced plastic 15. The layers of fibre-reinforced plastic 15 can be constructed identically or differently with regard to the polyamide-based matrix and the manner and arrangement of the fibre material.

FIG. 7 shows a layer structure of a composite material 16 according to example 1. The outer cover layers are formed by identical metallic layers 2, 3 each with a layer thickness of 0.25 mm. On the inside of the outer cover layers are arranged fibre-reinforced plastic layers 7, 7′ also each with a layer thickness of 0.25 mm, which are connected to the metallic layers via adhesion promotion agents 17. The fibre-reinforced plastic layer 7, 7′ in this case has a polyamide matrix and a fabric with carbon fibres running at right angles to each other and a fibre proportion of 45 vol. %. The tensile strength and density of the fibre-reinforced plastic layers 7, 7′ are Rₘ=785 MPa and ρ=1.43 g/cm³. The core layer is formed by a 0.5 mm thick, fibre-free polyamide layer 5. Since the plastic of the fibre-reinforced plastic layers 7, 7′ and the fibre-free plastic layer 5 are the same, if not totally identical, the plastic layers 5, 7, 7′ adhere to each other without the use of an adhesion promotion agent.

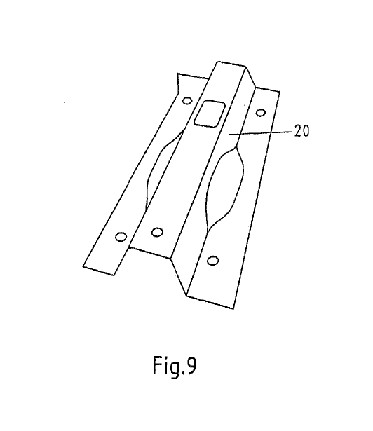

FIG. 8 shows a layer structure of a composite material 18 according to example 2. The outer cover layers are formed by identical metallic layers 2, 3 each with a layer thickness of 0.5 mm or 0.75 mm. On the inside of the outer cover layers are provided fibre-free polyamide layers 5, 5′ which adhere to the metallic layers 2, 3 without the use of an adhesion promotion agent. The core layer is formed by a fibre-reinforced, polyamide-based plastic layer 7. The fibre-reinforced plastic layer 7 has a polyamide matrix and a fabric with carbon fibres running at right angles to each other and a fibre proportion of 45 vol. %. The tensile strength and density of the fibre-reinforced plastic layer 7 are Rₘ=785 MPa and ρ=1.43 g/cm³. Since the plastic of the fibre-reinforced plastic layer 7 and fibre-free plastic layers 5, 5′ are the same, if not totally identical, the plastic layers adhere to each other without the use of an adhesion promotion agent.

FIG. 9 shows a structural component 20 made by forming from a composite material of the type described above. In the present case this is a tunnel reinforcement.

1. A composite material in the form of a laminated material of flat superimposed layers for production of a structural component comprising at least one metal layer and at least one fibre-reinforced plastic layer, wherein the fibre-reinforced plastic layer has a matrix comprising polypropylene, polyethylene, polyamide or mixtures thereof.

2. The composite material according to claim 1, further comprising at least one polyamide-based fibre-free plastic layer.

3. The composite material according to claim 1, wherein the matrix of the at least one fibre-reinforced plastic layer comprises polyethylene.

4. The composite material according to claim 1, wherein the matrix of the at least one fibre-reinforced plastic layer comprises styrene maleic acid anhydride (SMA).

5. The composite material according to claim 1, wherein the proportion of fibres in the at least one fibre-reinforced plastic layer is between 5 vol. % and 40 vol. %.

6. The composite material according to claim 1, wherein the at least one fibre-reinforced plastic layer comprises inorganic fibres, glass fibres, boron fibres, organic fibres, carbon fibres, protein fibres, plastic fibres, aramide fibres, polyethylene fibres, or a mixture thereof.

7. The composite material according to claim 1, wherein a proportion of fibres of the at least one fibre-reinforced plastic layer comprises a laid, knitted or woven fabric, or a unidirectional layer.

8. The composite material according to claim 1, wherein the at least one metal layer comprises steel, aluminium, or a mixture thereof.

9. The composite material according to claim 1, wherein the at least one metal layer has a tensile strength of less than 450 MPa.

10. The composite material according to claim 1, wherein the at least one metal layer has a thickness between 0 1 mm and 1 mm.

11. The composite material according to claim 1, wherein the at least one metal layer has a plurality of recesses, indentations or openings.

12. The composite material according to claim 1, wherein the at least one metal layer has a maximum proportion of 50 vol. % in relation to the composite material.

13. The composite material according to claim 1, wherein the composite material has a layer thickness between 0.5 mm and 4.0 mm.

14. (canceled)

15. A structural component for a motor vehicle comprising the composite material according to claim 1.

16. The composite material according to claim 1, further comprising an adhesion promotion layer having a first side and a second side wherein the first side is adjacent to the at least one fibre-reinforced plastic layer and the second side is adjacent to the at least one metal layer.

17. The composite material according to claim 2, wherein the matrix of the at least one fibre-free plastic layer comprises polyethylene.

18. The composite material according to claim 2, wherein the at least one fibre-free plastic layer comprises styrene maleic acid anhydride (SMA).

19. The composite material according to claim 1, wherein the proportion of fibres in the at least one fibre-reinforced plastic layer is between 5 vol. % and 20 vol. %.

20. The composite material according to claim 10, wherein the at least one metal layer has a maximum thickness of 0.75 mm.

21. The composite material according to claim 1, wherein the composite material has a layer thickness between 1.0 mm and 3.0 mm.
